(19) United States
(12) Patent Application Publication
(10) Pub. No.: US 2011/0233993 A1
(43) Pub. Date: Sep. 29, 2011

(54) VEHICULAR BRAKE CONTROL DEVICE FOR CONTROLLING BRAKE FLUID PRESSURE

(75) Inventor: Moriharu SAKAI, Kariya-city (JP)

(73) Assignee: ADVICS CO., LTD., Kariya-city (JP)

(21) Appl. No.: 13/156,474

(22) Filed: Jun. 9, 2011

Related U.S. Application Data
(63) Continuation of application No. 11/889,859, filed on Aug. 16, 2007.

(30) Foreign Application Priority Data
Aug. 22, 2006 (JP) 2006-225501

(51) Int. Cl. B60T 13/66; B60T 13/16

(52) U.S. Cl. 303/9.62

(57) ABSTRACT

A vehicular brake control device is installed in a vehicle and includes an actuator and a control unit. The actuator controls brake fluid pressures applied respectively to a first wheel cylinder for a front wheel and a second wheel cylinder for a rear wheel. The actuator includes a first pump for the front wheel, a second pump for the rear wheel, and a motor for driving the first pump and the second pump. The first pump sucks brake fluid and discharges the brake fluid to the first wheel cylinder. The second pump sucks brake fluid and discharges the brake fluid to the second wheel cylinder. In addition, a discharge volume of the first pump is larger than a discharge volume of the second pump.

### CROSS REFERENCE TO RELATED APPLICATION

This is a continuation application of U.S. application Ser. No. 11/889,859 filed on Aug. 16, 2007, which is incorporated herein by reference and which is based on and incorporates herein by reference Japanese patent application No. 2006-225501 filed on Aug. 22, 2006.

### FIELD OF THE INVENTION

The present invention relates to an actuator for controlling brake fluid pressures applied to wheel cylinders.

### BACKGROUND OF THE INVENTION

In an actuator for controlling brake fluid pressures, pumps are housed which suck and discharge brake fluid in order to supply each of wheel cylinders with brake fluid. A conventional art (for example, JP H11-208440A) is known that a motor controls both one of the pumps for a front wheel and another one of the pumps for a rear wheel. In this art, the pump for the front wheel discharges as much brake fluid as the pump for the rear wheel.

Because a volume of brake fluid used by a wheel cylinder for the front wheel is larger than that used by a wheel cylinder for the rear wheel, it is necessary in this art that the discharge volumes of the both pumps for the front wheel and the rear wheel are large enough to meet the requirement for the consumption volume of the wheel cylinder for the front wheel.

However, this results in an excessive discharge volume of brake fluid from the pump for the rear wheel. The surplus discharge volume increases the load of the motor, and accordingly raises the power consumption of the motor and the size of the actuator.

### SUMMARY OF THE INVENTION

It is therefore an object of the present invention to suppress the power consumption and reduce the size of an actuator in which a motor drives both a pump for a front wheel and a pump for a rear wheel.

In an aspect, a vehicular brake control device is installed in a vehicle including an actuator and a control unit. The actuator controls brake fluid pressures applied respectively to a first wheel cylinder for the front wheel and a second wheel cylinder for the rear wheel. The actuator includes a first pump for the front wheel, a second pump for the rear wheel, and a motor for driving the first pump and the second pump. The first pump sucks first brake fluid and discharges the first brake fluid to the first wheel cylinder. The second pump sucks brake fluid and discharges the brake fluid to the second wheel cylinder. In addition, a discharge volume of the first pump is larger than a discharge volume of the second pump.

Therefore, it is possible to suppress the power consumption of the motor and reduce the size of the actuator by reducing the volume of the brake fluid discharged from the second pump for the rear wheel.

The first pump and the second pump may be located side by side along an axial direction of a shaft of the motor and the first pump is closer to the motor than the second pump is.

In this case, the first pump producing a larger driving torque is located closer to the motor. Therefore, the shaft of the motor can be made thinner since a stress applied to the motor is smaller than in the case that the first pump producing the larger driving torque is located farther from the motor.

In the case that an end of the shaft farther from the motor is supported by a bearing, a load applied to the bearing becomes smaller and the bearing can accordingly be made smaller.

The first pump may be a gear pump for sucking and discharging the first brake fluid according to rotation of a first inner rotor and first outer rotor each having a teeth portion. In addition, the second pump may be a gear pump for sucking and discharging the brake fluid according to rotation of a second inner rotor and a second outer rotor each having a teeth portion. In this case, thicknesses of the first inner rotor and the first outer rotor may be larger than thicknesses of the second inner rotor and the second outer rotor.

The actuator may include a housing in which the first pump and the second pump are housed. The housing may have a first surface to which the motor is fixed and have a second surface opposite to the first surface. In addition, valves for controlling flow of the brake fluid discharged from the first and second pumps may be fixed to the second surface.

In this case, a suction port and a suction conduit may be formed in the housing, wherein the suction port sucks brake fluid from outside of the housing and the suction conduit connects the suction port with inlets of the first and second pumps. In addition, the suction conduit may be located closer to the first surface than to the second surface in the housing.

In this case, a portion of the housing closer to the first surface than to the second surface is thick, and therefore it is easy to form a large conduit in the portion. Therefore, by forming the suction conduit in the portion, it is possible to make a radius of the suction conduit to be large and accordingly reduce a resistance force applied to the brake fluid flowing in the suction conduit.

Besides, the actuator may include another set of the above elements in which another motor drives a third pump for another front wheel and a fourth pump for another rear wheel.

### BRIEF DESCRIPTION OF THE DRAWINGS

The invention, together with additional objective, features and advantages thereof, will be best understood from the following description, the appended claims and the accompanying drawings. In the drawings:

FIG. 1 is a diagram showing a hydraulic circuit configuration of a vehicle brake control device including a brake fluid pressure control actuator according to an embodiment of the present invention;

FIG. 2 is a block diagram showing input-output relationships of signals of a brake ECU that controls a control system of the vehicle brake control device shown in FIG. 1;

FIG. 3 is an elevation view of the brake fluid pressure control actuator shown in FIG. 1;

FIG. 4 is a cross-sectional view taken along the IV-IV line in FIG. 3; and

FIG. 5 is a schematic diagram showing operating states of portions in the vehicle brake control device in normal braking and in an abnormal situation.

### DETAILED DESCRIPTION OF EMBODIMENTS

An embodiment of the present invention will be described below with reference to the drawings.

An actuator for controlling brake fluid pressures (hereinafter referred to as a brake fluid pressure control actuator) according to an embodiment of the present invention is applied to a vehicle with an X-type hydraulic circuit including two conduit systems, one of which serves the right front wheel and the left rear wheel of the vehicle and the other of which serves the left front wheel and the right rear wheel of the vehicle.

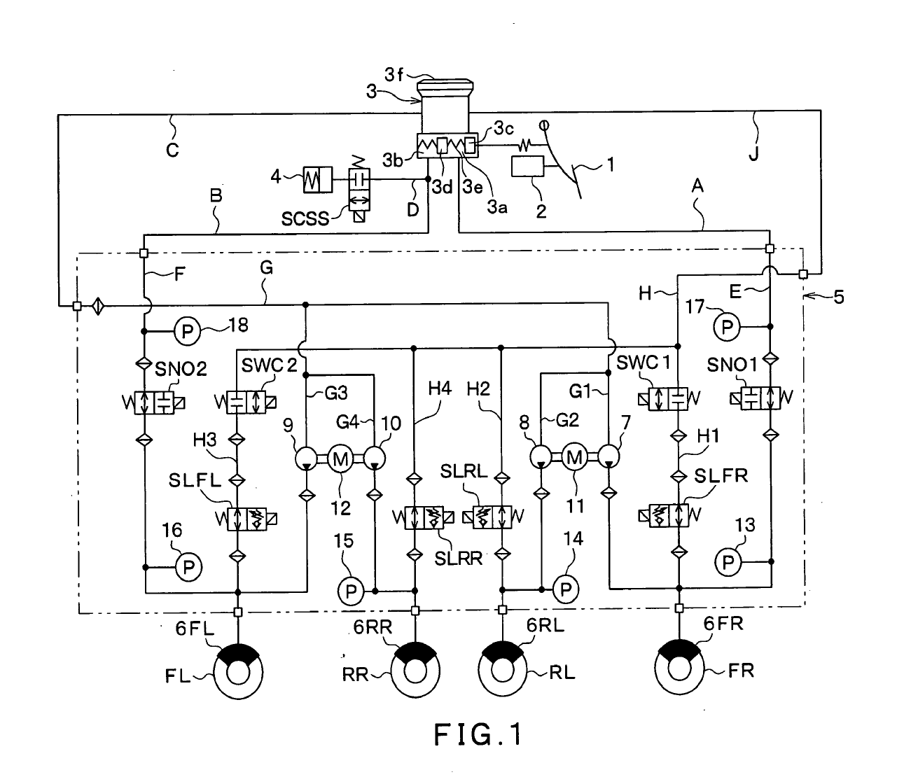

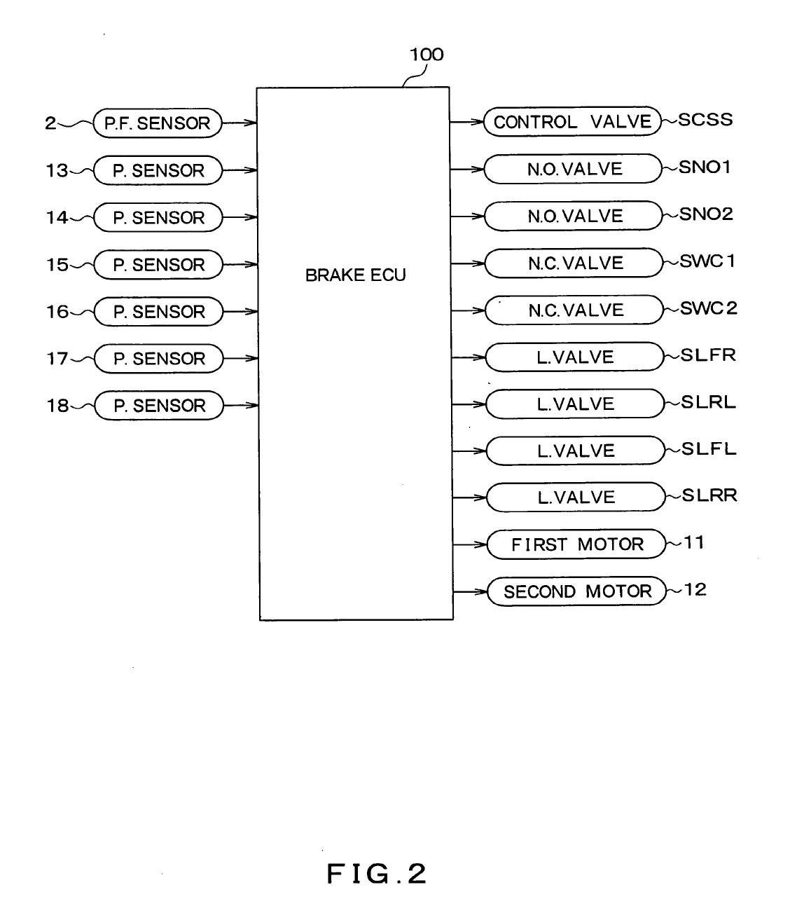

As shown in FIG. 1, the vehicle brake control device includes a brake pedal 1, a depression force sensor 2, a master cylinder (hereinafter referred to as an M/C) 3, a stroke control valve SCSS, a stroke simulator 4, the brake fluid pressure control actuator 5, and wheel cylinders (hereinafter referred to as W/Cs) 6FL, 6FR, 6RL, 6RR, as well as a brake ECU 100 shown in FIG. 2.

When the brake pedal 1, which is an example of a brake operating member, is depressed by a driver, the depression force applied to the brake pedal 1 is inputted to the depression force sensor 2, and a detection signal corresponding to the applied depression force is outputted by the depression force sensor 2. The detection signal is inputted to the brake ECU 100, and thus the depression force applied to the brake pedal 1 is detected by the brake ECU 100. Although the depression force sensor 2 is used as an example of an operation amount sensor for detecting an amount of operation to the brake operating member, a stroke sensor or the like may also be used as another example of the operation amount sensor. The vehicle brake control device may also be configured such that it detects a state of operation of the brake pedal 1 based on detection signals from a stroke sensor and pressure sensors 17 and 18, which detect an M/C pressure described later.

A push rod or the like is connected with the brake pedal 1 and transmits the applied depression force to the M/C 3. When the push rod or the like is pushed, the M/C pressure is generated in a primary chamber 3a and a secondary chamber 3b, which are provided in the M/C 3.

The M/C 3 includes a primary piston 3c and a secondary piston 3d, which form and demarcates the primary chamber 3a and the secondary chamber 3b. The primary piston 3c and the secondary piston 3d receive an elastic force of a spring 3e, thereby return the brake pedal 1 to its initial position when the brake pedal 1 becomes free from the depression force.

The vehicle brake control device also includes brake conduits A and B, which extend respectively from the primary chamber 3a and the secondary chamber 3b of the M/C 3 to the brake fluid pressure control actuator 5.

The M/C 3 also includes a master reservoir 3f. While the brake pedal 1 is in its initial position, the master reservoir 3f is connected with the primary chamber 3a and the secondary chamber 3b via channels not shown in FIG. 1, supplies brake fluid to the M/C 3, and stores any surplus brake fluid.

A brake conduit C directly extends from the master reservoir 3f to the brake fluid pressure control actuator 5. The brake conduit C is for supplying the brake fluid pressure control actuator 5 with the brake fluid. A brake conduit J is also provided which sends back brake fluid from the brake fluid pressure control actuator 5 to the master reservoir 3f.

The stroke simulator 4 is connected with a brake conduit D extending to the brake conduit B and receives the brake fluid in the secondary chamber 3b. The stroke control valve SCSS, a type of normally-closed two-position valve, is provided in the brake conduit D and controls open and closed states of the brake conduit D. A normally closed two-position valve opens a path to which it is fixed while electrical power is supplied to it, and closes the path while electrical power is not supplied to it. The configuration allows the stroke control valve SCSS to control the flow of brake fluid to the stroke simulator 4.

The brake fluid pressure control actuator 5 is configured as described below.

The actuator 5 includes a brake conduit E which is connected with the brake conduit A so that the primary chamber 3a is connected via the brake conduit E with the W/C (first front wheel W/C) 6FR, which corresponds to a right front wheel FR. A first normally-open valve (a first control valve) SNO1 is located in the brake conduit E. The first normally-open valve SNO1 is a two-position valve that opens a path to which it is fixed while electrical power is not supplied to it, and closes the path while electrical power is supplied to it. The first normally-open valve SNO1 controls the open and closed states of the brake conduit E.

The actuator 5 also includes a brake conduit F which is connected with the brake conduit B so that the secondary chamber 3b is connected via the brake conduit F with the W/C (second front wheel W/C) 6FL, which corresponds to a left front wheel FL. A second normally-open valve (a second control valve) SNO2 is located in the brake conduit F. The second normally-open valve SNO2 is a two-position valve that opens a path to which it is installed while electrical power is not supplied to it, and closes the path while electrical power is supplied to it. The second normally-open valve SNO2 thus controls the open and closed states of the brake conduit F.

The actuator also includes a brake conduit G which is connected with the brake conduit C that extends from the master reservoir 3f. The brake conduit G branches into four brake conduits called brake conduits G1, G2, G3, and G4 which are respectively connected with the first front W/C 6FR, the first rear W/C 6RL, the second front W/C 6FL, and the second rear W/C 6RR. The first rear W/C 6RL corresponds to the left rear wheel RL and the second rear W/C 6RR corresponds to the right rear wheel RR. Note that the brake conduit G includes the brake conduits G1 to G4.

Pumps 7, 8, 9, and 10 are located in the brake conduits G1, G2, G3, and G4, respectively. The first front pump 7 for supplying the first front W/C 6FR with the brake fluid and the first rear pump 8 for supplying the first rear W/C 6RL with the brake fluid are driven by a first motor 11. The second front pump 9 for supplying the second front W/C 6FL with the brake fluid and the second rear pump 10 for supplying the second rear W/C 6RR with the brake fluid are driven by a first motor 12. The first and second motors 11 and 12 are electrical motors. More specifically, the first and second motors 11 and 12 are brushless motors.

The brake conduit J extending from the master reservoir 3f is connected with a brake conduit H. The brake conduit H branches into four brake conduits H1, H2, H3 and H4, which are connected with the first front W/C 6FR, the first rear W/C 6RL, the second front W/C 6FL, and the second rear W/C 6RR, respectively. Note that the brake conduit H includes the brake conduits H1 to H4.

A first normally-closed valve (third control valve) SWC1 and a first liner valve SLFR are located in series in the brake conduit H1 which is connected with the first front W/C 6FR. More specifically, the first normally-closed valve SWC1 is located closer to the master reservoir 3f than the first linear valve SLFR is. Thus, the first normally-closed valve SWC1 can open and close a path between the master reservoir 3f and the first liner valve SLFR.

A second liner valve SLRL is located in the brake conduit H2 which is connected with the first rear W/C 6RL.

A second normally-closed valve (fourth control valve) SWC2 and a third liner valve SLFR are located in series in the brake conduit H3 which is connected with the second front W/C 6FL. More specifically, the second normally-closed valve SWC2 is located closer to the master reservoir 3f than the third liner valve SLFL is. Thus, the second normally-closed valve SWC2 can open and close a path between the master reservoir 3f and the third liner valve SLFL.

A fourth liner valve SLRR is located in the brake conduit H4 which is connected with the second rear W/C 6RR.

Pressure sensors (first to four pressure sensors) 13, 14, 15, and 16 are located, respectively, between the first normally-open valve SNO1 and the right front W/C 6FR in the brake conduit E, between the pump 8 and the left rear W/C 6RL in the brake conduit G2, between the pump 10 and the right rear W/C 6RR in the brake conduit G4, and between the second normally-open valve SNO2 and the second front W/C 6FL in the brake conduit F. Thus it is possible to detect the W/C pressures.

A pressure sensor 17 is located at an upstream side (M/C 3 side) of the first normally-open valve SNO1, and a pressure sensor 18 located at an upstream side (M/C 3 side) of the second normally-closed valve SWC2. It is therefore possible to detect M/C pressures generated in the primary chamber 3a and the secondary chamber 3b of the M/C 3.

Thus, a first conduit system is composed of a first auxiliary conduit, a main conduit, a first pressure control conduit, and a second pressure control conduit. The first auxiliary conduit is a fluid pressure circuit connecting the primary chamber 3a with the first front W/C 6FR through the brake conduits A and E. The main conduit is a fluid pressure circuit connecting the master reservoir 3f and first front W/C 6FR and connecting the master reservoir 3f and the first rear W/C 6RL through the brake conduits C, G, G1, and G2. The first pressure control conduit is a fluid pressure circuit of the brake conduit H1 which is connected parallel to the first front pump 7. The second pressure control conduit is a fluid pressure circuit of the brake conduit H2 which is connected parallel to the first rear pump 8.

A second conduit system is composed of a second auxiliary conduit, another main conduit, a third pressure control conduit, and a fourth pressure control conduit. The second auxiliary conduit is a fluid pressure circuit connecting the secondary chamber 3b with the second front W/C 6FL through the brake conduits B and F. The main conduit is a fluid pressure circuit connecting the master reservoir 3f and second front W/C 6FL and connecting the master reservoir 3f and the second rear W/C 6RR through the brake conduits C, G, G3, and G4. The third pressure control conduit is a fluid pressure circuit of the brake conduit H3 which is connected parallel to the second front pump 9. The fourth pressure control conduit is a fluid pressure circuit of the brake conduit H4 which is connected parallel to the second rear pump 10.

As shown in FIG. 2, detection signals from the depression force sensor 2 and the pressure sensors 13 to 18 are inputted into the brake ECU 100, which calculates the depression force, the W/C pressures, and the M/C pressure and outputs detection signals based on the calculated values in order to drive the control valves SCSS, SNO1, SNO2, SWC1, SWC2, SLFR, SLRL, SLFL, SLRR, the first motor 11, and the second motor 12.

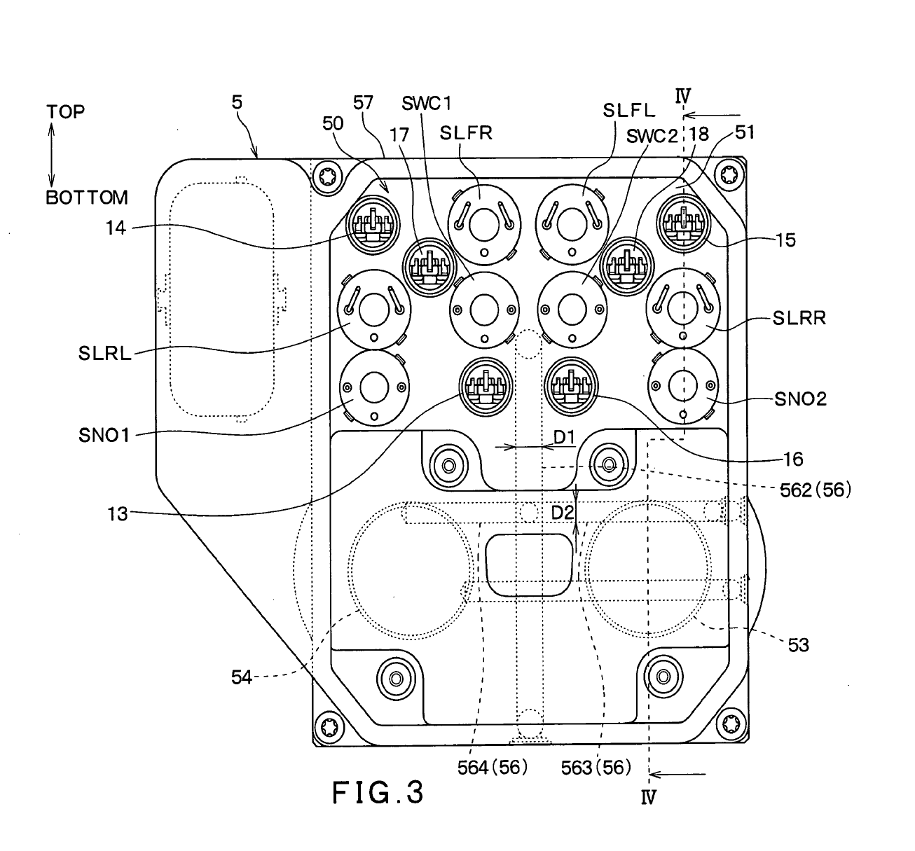

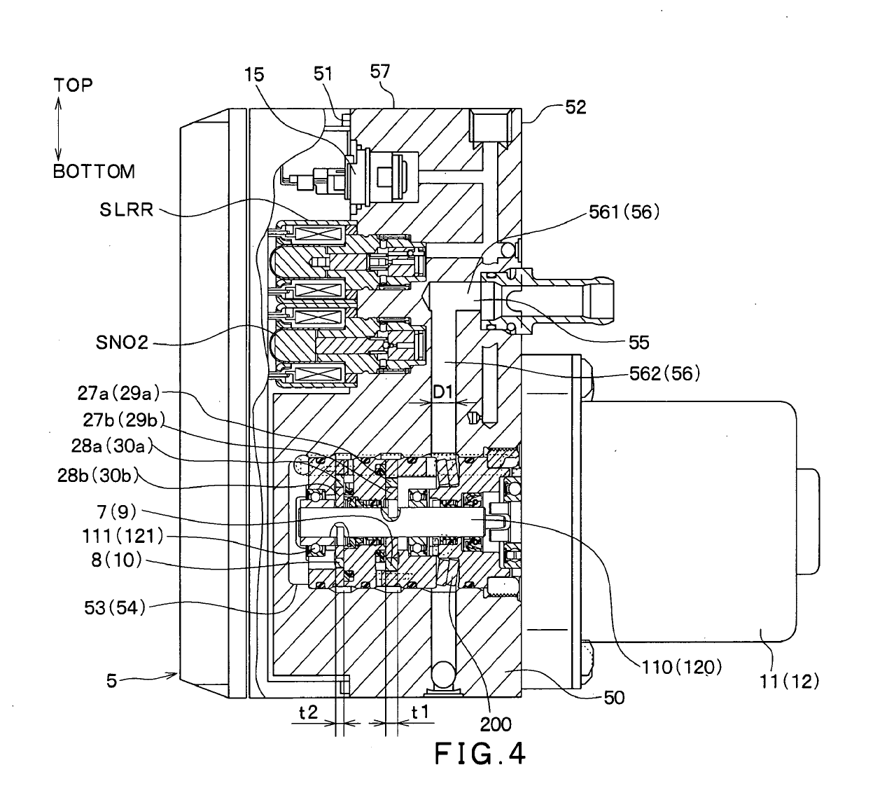

Hereinafter, the structure of the brake fluid pressure control actuator 5 is described with reference to FIGS. 3 and 4. FIG. 3 is an elevation view of the actuator of the present embodiment and FIG. 4 is a cross-sectional view which is taken along the IV-IV line in FIG. 3 and is sighted to the left in FIG. 3. As shown in FIG. 3, the cross-sectional view is composed of cross sections on different levels. Arrows in FIGS. 3 and 4 indicates the upward direction and the downward direction of the actuator 5 in the case that the actuator is installed in the vehicle.

The actuator 5 includes a metal housing 50 which is, for example, made of aluminum base alloy. The housing 50 has a shape similar to a rectangular parallelepiped. The control valves SNO1, SNO2, SWC1, SWC2, SLFR, SLRL, SLFL, SLRR, and the pressure sensors 13 to 18 are installed to an upper portion of a valve-installation surface 51. The valve-installation surface 51 is a vertical surface and is one of the surfaces of the housing 50. The valve-installation surface 51 serves as a second surface.

A pump-installation surface 52 is formed on a side of the housing 50 opposite to the valve-installation surface 51. The pump-installation surface 52 is a vertical surface and is one of the surfaces of the housing 50. The first and second motors 11 and 12 are fixed to a lower portion of the pump-installation surface 52. The pump-installation surface 52 serves as a first surface.

Two pump-insertion holes 53 and 54 are formed at a lower part of the housing 50. The holes 53 and 54 extend parallel to each other and also extend in the direction vertical to the pump-installation surface 52. The first front pump 7 and the first rear pump 8 are inserted in the pump-insertion hole 53, while the second front pump 9 and the second rear pump 10 are inserted in the pump-insertion hole 54.

The first front pump 7 and the first rear pump 8 are located side by side along the axial direction of a first motor shaft 110 which is also inserted in the pump-insertion hole 53. The first motor shaft 110 is a spindle which transmits a rotational force produced by the first motor to the pumps 7 and 8. The first front pump 7 is located closer to the first motor 11 than the first rear pump 8 is. The second front pump 9 and the second rear pump 10 are located side by side along the axial direction of a second motor shaft 120 which is also inserted in the pump-insertion hole 54. The second motor shaft 120 is a spindle which transmits a rotational force produced by the first motor to the pumps 9 and 10. The second front pump 9 is located closer to the second motor 12 than the second rear pump 10 is.

The pumps 7 to 10 are rotary pumps. More specifically, the pumps 7 to 10 are internal gear pumps. As is well-known, each of the internal gear pumps includes an outer rotor 27a, 28a, 29a, 30a having inner teeth portion and an inner rotor 27b, 28b, 29b, 30b having outer teeth, wherein the inner teeth and the outer teeth mesh with each other to form rooms. The internal gear pump sucks and discharges fluid (more specifically, brake fluid in the present embodiment) when the inner rotor is rotated by the rotation of the motor shaft and the volumes of the rooms accordingly change.

The volumes of the brake fluid discharged from the first front pump 7 and the second front pump 9 are made to be larger than the volumes of the brake fluid discharged from the first rear pump 8 and the second rear pump 10. In other words, the volumes of the brake fluid discharged from the first rear pump 8 and the second rear pump 10 are suppressed in order to prevent them from becoming too excessive.

The first front W/C 6FR and the second front W/C 6FL use more brake fluid than the first rear W/C 6RL and the second rear W/C 6RR. In the present embodiment, a thickness t1 of the each of the rotors 27a, 27b of the first front pump 7 in the axial direction of the first motor shaft 110 is made to be larger than a thickness t2 of the each of the rotors 28a, 28b of the first rear pump 8 in the axial direction of the first motor shaft 110. In addition, a thickness t1 of the each of rotors 29a, 29b of the second front pump 9 in the axial direction of the second motor shaft 120 is made to be larger than a thickness t2 of the each of the rotors 30a, 30b of the second rear pump 10 in the axial direction of the second motor shaft 120.

Therefore, a volume of brake fluid discharged from the first front pump 7 is larger than a volume of brake fluid discharged from the first rear pump 8. In addition, a volume of brake fluid discharged from the second front pump 9 is larger than a volume of brake fluid discharged from the second rear pump 10.

A use ratio of a volume of brake fluid used by the first front W/C 6FR to a volume of brake fluid used by the first rear W/C 6RL is designed depending on what type of vehicle the W/Cs are installed in. In the same way, a use ratio of a volume of brake fluid used by the second front W/C 6FL to a volume of brake fluid used by the second rear W/C 6RR is also designed depending on what type of vehicle the W/Cs are installed in.

In manufacturing the actuator 5, a thickness ratio between the rotor thicknesses t1 and t2 is adjusted to match the designed use ratio. Otherwise, a radius ratio between radiuses of the rotors of the first front pump 7 and the rotors of the first rear pump 8 can be adjusted to match the designed use ratio. In addition, a radius ratio between radiuses of the rotors of the second front pump 9 and the rotors of the second rear pump 10 can be adjusted to match the designed use ratio.

It is possible that two vehicles have the use ratios of the same value but have different total volumes of brake fluid used by the W/Cs 6FL, 6FR, 6RL, 6RR, if the rotational speeds of the first and second motors 11 and 12 in one of the vehicles differ from the other one of the vehicles. The rotational speeds of the first and second motors 11 and 12 correspond to the rotational speeds of the pumps.

A total thickness of pumps aligned in a motor shaft in the direction of a motor shaft changes depending on the thickness ratio between the rotor thicknesses t1 and t2. Therefore, positions of an inlet and an outlet of each of the pumps relative to the housing 50 vary depending on the thickness ratio of the pumps. In this case, positions of conduits for brake fluid in the housing 50 have to be adjusted depending on the thickness ratio. Therefore, the shape of the housing 50 had to be designed depending on the ratio between volumes of brake fluid discharged by a pump for a front wheel and a pump for a rear wheel.

To solve this problem, both the thicknesses of the rotors and the rotational speeds of the pumps are adjusted to satisfy the requirements for each vehicle regarding the volumes of the brake fluid discharged from the pumps. In addition, the housing 50 can be manufactured to be compatible with the ratio t1/t2 of the rotor thicknesses varying from 1.3 to 2. Thus, the multipurpose housing 50 can be used for pumps with various rotor thicknesses. Therefore, it is unnecessary to manufacture multiple types of the housing 50, which has a complex structure of many conduits for the brake fluid. As a result, the housing 50 can be manufactured with low cost. When the total thickness of the pumps becomes longer, a degree of deformation of a disc spring 200 increases to compensate for the increase in the thickness.

An suction port 55 is formed at a portion of the pump-installation surface 52 and located above the inlets of the pumps 7 to 10 and the motors 11 and 12. brake fluid from the master reservoir 3f flows into the suction port 55.

The suction port 55 is connected with the inlets of the pumps 7 to 10 through an suction conduit 56. The suction conduit 56 includes a crosswise conduit 561 and a vertical conduit 562.

The crosswise conduit 561 extends from the suction port 55 perpendicularly to the pump-installation surface 52 (in other words, crosswise or horizontally). The vertical conduit 562 extends from the crosswise conduit 561 downwards (in other words, vertically) toward the pump-insertion holes 53 and 54. The suction conduit 56 also includes diversion conduits 563 and 564 which diverge from the vertical conduit 562. The diversion conduit 563 is connected with the inlets of the pumps 7 and 8 while the diversion conduit 564 is connected with the inlets of the pumps 9 and 10.

The diameters D1 of the crosswise conduit 561 and the vertical conduit 562 are 1.3 to 3 times as large as the diameters D2 of the diversion conduits 563 and 564. The crosswise conduit 561 and the vertical conduit 562 are located in the housing 50 closer to the pump-installation surface 52 than to the valve-installation surface 51. At the location the thickness of the housing 50 is large and it is therefore easy to form large conduits such as the crosswise conduit 561 and vertical conduit 562 having the diameters of D1.

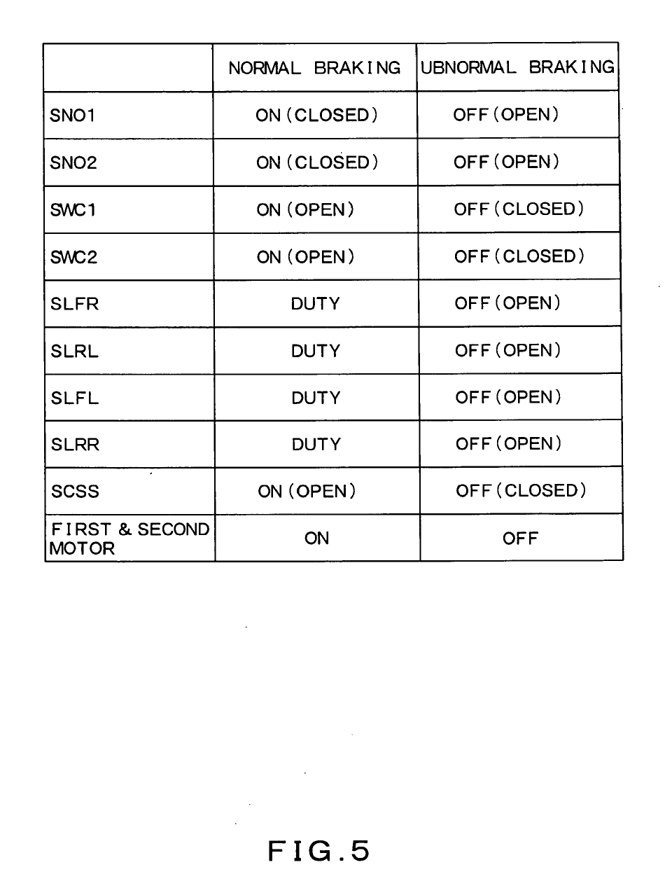

The operation of the brake control device during normal braking and in an abnormal situation will be described below separately. FIG. 5 is a table showing the operating states of portions of the vehicle brake control device during the normal braking and when the abnormal situation occurs in the vehicle brake control device.

The brake ECU 100 determines, by executing a conventional initial check or the like, whether or not the abnormal situation has arose. If the abnormal situation arises, abnormal-state braking operation is executed until the abnormal situation goes away.

(1) Operation During the Normal Braking

During normal braking, when the brake pedal 1 is depressed and the detection signal from the brake depression force sensor 2 is inputted to the brake ECU 100, the brake ECU 100 operates the various control valves SCSS, SNO1, SNO2, SWC1, SWC2, SLFR, SLRL, SLFL, SLRR, and the first and second motors 11, 12 such that they are in the operating states shown in FIG. 5.

Electric power to both the first and second normally-open valves SNO1 and SNO2 is turned to ON, and electric power to both the first and second normally-closed valves SWC1 and SWC2 is turned to ON. Therefore, the first and second normally-open valves SNO1 and SNO2 are both put into a closed state, and the first and second normally-closed valves SWC1 and SWC2 are both put into an open state.

The ON/OFF switching of electric power to the first to fourth linear valves SLFR, SLRL, SLFL, SLRR is subject to duty control (or PWM control), and therefore the first to fourth linear valves SLFR, SLRL, SLFL, SLRR are switched between a closed state and an open state. Electric power to the stroke control valve SCSS is turned to ON, causing the stroke simulator 4 to be connected with the secondary chamber 3b through the brake conduits B and D. In this case, the brake fluid in the secondary chamber 3b moves to the stroke simulator 4 when the brake pedal is depressed and the pistons 3c and 3d move. Therefore, when the driver depresses the pedal 1, the brake pedal 1 can be depressed without making the driver feel that depressing the brake pedal 1 becomes like pressing a hard board (i.e. giving a board feeling) as a result of the increase in the master cylinder pressure.

In addition, power supply to the first and second motors 11 and 12 is turned to ON and the pumps 7 to 10 draws in and discharges the brake fluid. In this manner, the brake fluid is supplied to the W/Cs 6FR to 6RR when the pumps 7 to 10 perform pumping operation.

Since the first and second normally-open valves SNO1 and SNO2 are in a closed state at this time, the brake fluid pressures downstream of the pumps 7 to 10, that is, the W/C pressures of the W/Cs 6FR to 6RR, are increased. Since the first and second normally-closed valves SWC1 and SWC2 are in an open state and the first to fourth linear valves SLFR, SLRL, SLFL, and SLRR are subject to duty control, the W/C pressures of the W/Cs 6FR to 6RR are adjusted according to duty factors of the current value for the linear valves SLFR, SLRL, SLFL, and SLRR.

The brake ECU 100 monitors the W/C pressures in the W/Cs 6FR to 6RR based on the detection signals from the pressure sensors 13 to 16. The brake ECU 100 accordingly adjusts the W/C pressures to desired values by adjusting the amounts of electric power supplied to the first and second motors 11 and 12 to control the revolution speeds thereof and by controlling the ON/OFF duty ratios for the electric power that is supplied to the first to fourth linear valves SLFR, SLRL, SLFL, and SLRR.

Thus, braking force is generated according to the depression force of operation performed to the brake pedal 1.

(2) Abnormal-State Braking Operation

When an abnormal situation arises in the vehicle brake control device, there is a possibility that control signals cannot be outputted from the brake ECU 100, or that some of the control valves SCSS, SNO1, SNO2, SWC1, SWC2, SLFR, SLRL, SLFL, SLRR or the first and second motors 11, 12 do not work properly. In this case, electric power to the various control valves SCSS, SNO1, SNO2, SWC1, SWC2, SLFR, SLRL, SLFL, SLRR and the first and second motors 11, 12 is turned to OFF as shown in FIG. 5.

Since the electric power to both the first and second normally-open valves SNO1 and SNO2 is turned to OFF, both valves SNO1 and SNO2 are in the open states. Since the electric power to both the first and second normally-closed valves SWC1 and SWC2 is turned to OFF, both valves SWC1 and SWC2 are in the closed states.

Since the electric power to all of the first to fourth linear valves SLFR, SLRL, SLFL, and SLRR is turned to OFF, they are in the open states. Since electric power to the stroke control valve SCSS is also turned to OFF, the stroke simulator 4 and the secondary chamber 3b are cut off from each other.

Since the electric power to the first and second motors 11 and 12 is turned to OFF, the pumps 7 to 10 stop drawing in and discharging the brake fluid.

At this time, the primary chamber 3a of the M/C 3 is in a state in which it is connected with the first front W/C 6FR via the brake conduits A and E, and the secondary chamber 3b is in a state in which it is connected with the second front W/C 6FL via the brake conduits B, F, and G3.

Therefore, if the brake pedal 1 is depressed and the push rod or the like is pushed according to the applied depression force, the M/C pressure is generated in the primary chamber 3a and the secondary chamber 3b and the M/C pressure is transmitted to the first front W/C 6FR and the second front W/C 6FL. Braking force is thereby generated for both front wheels FR and FL.

The brake control device of the present embodiment has advantages described below.

(1) During normal braking, as described above, the vehicle brake control device generates the W/C pressures in the W/Cs 6FR to 6RR by operating the various control valves SCSS, SNO1, SNO2, SWC1, SWC2, SLFR, SLRL, SLFL, SLRR and the first and second motors 11, 12, thereby causing the pumps 7 to 10 to pressurize the W/Cs 6FR to 6RR.

When an abnormal situation occurs in the vehicle brake control device, the vehicle brake control device can generate the W/C pressures in the first front W/C 6FR and second front W/C 6FL by means of the M/C pressures that are generated in the primary chamber 3a and the secondary chamber 3b by depressing of the brake pedal 1, without operating the various control valves SCSS, SNO1, SNO2, SWC1, SWC2, SLFR, SLRL, SLFL, SLRR or the first and second motors 11, 12.

In other words, the relationship between the supply of brake fluid from the M/C 3 and the input of the depression force on the brake pedal 1 is not mechanically severed. Therefore, even if some sort of abnormality occurs in the vehicle brake control device, braking force can be generated reliably without depending on the control performed by the brake ECU 100. Thus the vehicle brake control device has a structure that is effectively fail-safe. More specifically, in the vehicle brake control device, the W/C pressures are generated mechanically by the operation of the brake pedal 1 by the driver when an abnormal situation arises (i.e. when fail-safe operation is carried out.)

(2) The volumes of the brake fluid discharged from the first front pump 7 and the second front pump 9 are made to be larger than the volumes of the brake fluid discharged from the first rear pump 8 and the second rear pump 10 in order to adapt the fact that the first front W/C 6FR and the second front W/C 6FL use more brake fluid than the first rear W/C 6RL and the second rear W/C 6RR. In other words, the volumes of the brake fluid discharged from the first rear pump 8 and the second rear pump 10 are suppressed in order to prevent them from becoming too excessive.

Therefore, the driving torque generated at the first rear pump 8 and the second rear pump 10 becomes smaller and the load of the first and second motors 11 and 12 accordingly are decreased. As a result, the power consumption of the first and second motors 11 and 12 is suppressed and the size of the actuator 5 can be reduced.

(3) The first front pump 7 and second front pump 9 producing larger driving torques are located closer to the motor than the first rear pump 8 and second rear pump 10 are. Therefore, the shafts of the first and second motors 11 and 12 can be made thinner since stresses applied to the motors are smaller than in the case that the first front pump 7 and the second front pump 9 are located farther from the first and second motors 11 and 12.

In addition, loads applied to bearings 111 and 121, which respectively support an end of the first and second motor shaft 110 and 120 farther from the first and second motors 110 and 120, become smaller and the bearings 111 and 121 can accordingly be made smaller.

(4) A portion of the housing 50 closer to the valve-installation surface 51 than to the pump-installation surface 52 is thick, and therefore it is easy to form a large conduit in the portion. Therefore, by locating the crosswise conduit 561 and the vertical conduit 562 in the portion, it is possible to increase the diameters D1 of the crosswise conduit 561 and the vertical conduit 562 and accordingly reduce resistance forces applied to the brake fluid flowing in the crosswise conduit 561 and the vertical conduit 562.

### Other Embodiments

In the above embodiment, internal gear pumps serve as the pumps 7 to 10, respectively. However, each of the pumps 7 to 10 can be a rotary pump of another type or a reciprocating pump.

In the above embodiment, each of the W/Cs is provided with a pump. However, in the case that the vehicle brake device includes a front-rear type hydraulic circuit having a conduit system for both the front right wheel and the front left wheel and another conduit system for both the rear right wheel and the rear left wheel, each of the conduit system may be provided with a single pump. More specifically, a single motor may drive both a pump for the front wheels and a pump for the rear wheels, wherein the pump for the front wheels supplies a conduit system for the front wheels with brake fluid and the pump for the rear wheels supplies the other conduit system for the rear wheels with the brake fluid. In this case, a volume of the brake fluid discharged by the pump for the front wheels may be larger than a volume of the brake fluid discharged by the pump for the rear wheels.

What is claimed is:

1. A vehicular brake control device installed in a vehicle comprising an actuator and a control unit,
the actuator controlling brake fluid pressures applied respectively to a first wheel cylinder for a front wheel and a second wheel cylinder for a rear wheel, the actuator comprising:
a first pump for the front wheel, the first pump sucking brake fluid and discharging the brake fluid to the first wheel cylinder;
a second pump for the rear wheel, the second pump sucking brake fluid and discharging the brake fluid to the second wheel cylinder; and
a motor for driving the first pump and the second pump,
wherein a discharge volume of the first pump is larger than a discharge volume of the second pump, and
wherein the control unit adjusts, based on a monitored value of at least one of the brake fluid pressures applied respectively to the first wheel cylinder and the second wheel cylinder, the one of the brake fluid pressures controlling revolution speed of the motor and a degree of opening of a valve controlling flow of the brake fluid.

2. The vehicular brake control device according to claim 1, wherein the first pump and the second pump are located side by side along an axial direction of a shaft of the motor and the first pump is closer to the motor than the second pump is.

3. The vehicular brake control device according to claim 1, wherein:
the first pump is a gear pump for sucking and discharging the brake fluid according to rotation of a first inner rotor and a first outer rotor each having a teeth portion;
the second pump is a gear pump for sucking and discharging the brake fluid according to rotation of a second inner rotor and a second outer rotor each having a teeth portion; and
thicknesses of the first inner rotor and the first outer rotor are larger than thicknesses of the second inner rotor and the second outer rotor.

4. The vehicular brake control device according to claim 1, further comprising:
a housing in which the first pump and the second pump are housed, the housing having a first surface to which the motor is fixed and having a second surface opposite to the first surface; and
valves fixed to the second surface, the valves controlling flow of the brake fluid,
wherein:
an suction port and an suction conduit are formed in the housing, the suction port sucking brake fluid from outside of the housing, the suction conduit connecting the suction port with inlets of the first and second pumps; and
the suction conduit is located closer to the first surface than to the second surface in the housing.

5. The vehicular brake control device according to claim 1, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein a discharge volume of the third pump is larger than an a discharge volume of the fourth pump.

6. The vehicular brake control device according to claim 2, wherein:
the first pump is a gear pump for sucking and discharging the brake fluid according to rotation of a first inner rotor and a first outer rotor each having a teeth portion;
the second pump is a gear pump for sucking and discharging the brake fluid according to rotation of a second inner rotor and a second outer rotor each having a teeth portion; and
thicknesses of the first inner rotor and the first outer rotor are larger than thicknesses of the second inner rotor and the second outer rotor.

7. The vehicular brake control device according to claim 2, further comprising:
a housing in which the first pump and the second pump are housed, the housing having a first surface to which the motor is fixed and having a second surface opposite to the first surface; and
valves fixed to the second surface, the valves controlling flow of the brake fluid,
wherein:
a suction port and a suction conduit are formed in the housing, the suction port sucking brake fluid from outside of the housing, the suction conduit connecting the suction port with inlets of the first and second pumps; and
the suction conduit is located closer to the first surface than to the second surface in the housing.

8. The vehicular brake control device according to claim 2, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than discharge volume of the fourth pump;
the third pump and the fourth pump are located side by side along an axial direction of a shaft of the another motor; and
the third pump is closer to the another motor than the fourth pump is.

9. The vehicular brake control device according to claim 3, further comprising:
a housing in which the first pump and the second pump are housed, the housing having a first surface to which the motor is fixed and having a second surface opposite to the first surface; and
valves fixed to the second surface, the valves controlling flow of the brake fluid,
wherein:
a suction port and a suction conduit are formed in the housing, the suction port sucking brake fluid from outside of the housing, the suction conduit connecting the suction port with inlets of the first and second pumps; and
the suction conduit is located closer to the first surface than to the second surface in the housing.

10. The vehicular brake control device according to claim 3, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump is a gear pump for sucking and discharging the brake fluid according to rotation of a third inner rotor and a third outer rotor each having a teeth portion;
the second pump is a gear pump for sucking and discharging the brake fluid according to rotation of a fourth inner rotor and a fourth outer rotor each having a teeth portion; and
thicknesses of the third inner rotor and the third outer rotor are larger than thicknesses of the fourth inner rotor and the fourth outer rotor.

11. The vehicular brake control device according to claim 4, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump and the fourth pump are housed in the housing;
the another motor is fixed to the first surface;
the valves further control flow of the brake fluid; and
the suction conduit further connects the suction port with inlets of the third and fourth pumps.

12. The vehicular brake control device according to claim 6, further comprising:
a housing in which the first pump and the second pump are housed, the housing having a first surface to which the motor is fixed and having a second surface opposite to the first surface; and
valves fixed to the second surface, the valves controlling flow of the brake fluid,
wherein:
a suction port and a suction conduit are formed in the housing, the suction port sucking brake fluid from outside of the housing, the suction conduit connecting the suction port with inlets of the first and second pumps; and
the suction conduit is located closer to the first surface than to the second surface in the housing.

13. The vehicular brake control device according to claim 6, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump and the fourth pump are located side by side along an axial direction of a shaft of the another motor;
the third pump is closer to the another motor than the fourth pump is;
the third pump is a gear pump for sucking and discharging the brake fluid according to rotation of a third inner rotor and a third outer rotor each having a teeth portion;
the second pump is a gear pump for sucking and discharging the brake fluid according to rotation of a fourth inner rotor and a fourth outer rotor each having a teeth portion; and
thicknesses of the third inner rotor and the third outer rotor are larger than thicknesses of the fourth inner rotor and the fourth outer rotor.

14. The vehicular brake control device according to claim 7, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump and the fourth pump are located side by side along an axial direction of a shaft of the another motor;
the third pump is closer to the another motor than the fourth pump is;
the third pump and the fourth pump are housed in the housing;
the another motor is fixed to the first surface;
the valves further control flow of the brake fluid; and
the suction conduit further connects the suction port with inlets of the third and fourth pumps.

15. The vehicular brake control device according to claim 9, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump is a gear pump for sucking and discharging the brake fluid according to rotation of a third inner rotor and a third outer rotor each having a teeth portion;
the second pump is a gear pump for sucking and discharging the brake fluid according to rotation of a fourth inner rotor and a fourth outer rotor each having a teeth portion; and
thicknesses of the third inner rotor and the third outer rotor are larger than thicknesses of the fourth inner rotor and the fourth outer rotor;
the third pump and the fourth pump are housed in the housing;
the another motor is fixed to the first surface;
the valves further control flow of the brake fluid; and
the suction conduit further connects the suction port with inlets of the third and fourth pumps.

16. The vehicular brake control device according to claim 12, the actuator further for controlling brake fluid pressures applied respectively to a third wheel cylinder for another front wheel and a fourth wheel cylinder for another rear wheel, the actuator further comprising:
a third pump for the another front wheel, the third pump sucking brake fluid and discharging the brake fluid to the third wheel cylinder;
a fourth pump for the another rear wheel, the fourth pump sucking brake fluid and discharging the brake fluid to the fourth wheel cylinder; and
another motor for driving the third pump and the fourth pump,
wherein:
a discharge volume of the third pump is larger than a discharge volume of the fourth pump;
the third pump and the fourth pump are located side by side along an axial direction of a shaft of the another motor;
the third pump is closer to the another motor than the fourth pump is;
the third pump is a gear pump for sucking and discharging the brake fluid according to rotation of a third inner rotor and a third outer rotor each having a teeth portion;
the second pump is a gear pump for sucking and discharging the brake fluid according to rotation of a fourth inner rotor and a fourth outer rotor each having a teeth portion; and
thicknesses of the third inner rotor and the third outer rotor are larger than thicknesses of the fourth inner rotor and the fourth outer rotor;
the third pump and the fourth pump are housed in the housing;
the another motor is fixed to the first surface;
the valves further control flow of the brake fluid; and
the suction conduit further connects the suction port with inlets of the third and fourth pumps.
